(19) United States
(12) Patent Application Publication
(10) Pub. No.: US 2025/0078439 A1
(43) Pub. Date: Mar. 6, 2025

(54) ELECTRONIC DEVICE AND CONTROL METHOD FOR ELECTRONIC DEVICE

(71) Applicant: CANON KABUSHIKI KAISHA, Tokyo (JP)

(72) Inventor: TAKU ITO, Kanagawa (JP)

(21) Appl. No.: 18/820,562

(22) Filed: Aug. 30, 2024

(30) Foreign Application Priority Data
Sep. 5, 2023 (JP) 2023-143419

(51) Int. Cl. G06V 10/20; G06V 40/18

(52) U.S. Cl. CPC G06V 10/255; G06V 40/193

(57) ABSTRACT

An electronic device includes: a processor; and a memory storing a program which, when executed by the processor, causes the electronic device to: perform estimation processing for estimating a visually recognized range of a user; perform specifying processing for specifying an object that is visually recognized by the user, based on the visually recognized range; and perform collection processing for collecting information related to a visually recognized object, which is the object specified in the specifying processing, wherein, in the specifying processing, attribute information that is visually recognized by the user is specified among pieces of attribute information displayed together with the visually recognized object, and wherein, in the collection processing, information related to the visually recognized object is collected, based on the attribute information specified in the specifying processing.

### BACKGROUND OF THE INVENTION

### Field of the Invention

The present invention relates to an electronic device and a method for controlling the electronic device.

### Description of the Related Art

A line of sight of a user is used as means for estimating the interest of the user without user input such as a search word or a conditional filter. For example, it is possible to estimate a subject, in which the user is interested, by detecting where on a screen of a head-mounted display (HMD), a personal computer (PC), or the like, the user is looking at.

Japanese Patent Application Laid-open No. 2021-174446 discloses a method of calculating the level of user preference for a product, based on the line-of-sight movement history of the user relative to the product and the purchase history of the product, and proposing a recipe using the product. Further, Japanese Patent Application Laid-open No. 2008-243058 discloses a method of quantifying, based on a viewing time during which a research subject has viewed advertisement content, a level of research subject's interest in the content displayed at a viewed spot during the viewing time.

In a case where a related product is presented to the user in accordance with a product in which the user has shown interest, unless it is known what point of the product attracts interest of the user, it is difficult to estimate a related product that is likely to capture interest of the user. That is, it is difficult to appropriately collect and present information related to the subject (product) in which the user shows interest.

### SUMMARY OF THE INVENTION

The present invention provides an electronic device for collecting and presenting information that better matches the interest of a user.

An electronic device according to the present invention includes: a processor; and a memory storing a program which, when executed by the processor, causes the electronic device to: perform estimation processing for estimating a visually recognized range of a user; perform specifying processing for specifying an object that is visually recognized by the user, based on the visually recognized range; and perform collection processing for collecting information related to a visually recognized object, which is the object specified in the specifying processing, wherein, in the specifying processing, attribute information that is visually recognized by the user is specified among pieces of attribute information displayed together with the visually recognized object, and wherein, in the collection processing, information related to the visually recognized object is collected, based on the attribute information specified in the specifying processing.

Further features of the present invention will become apparent from the following description of exemplary embodiments with reference to the attached drawings.

### BRIEF DESCRIPTION OF THE DRAWINGS

FIGS. 1A and 1B are external views of an HMD;

FIG. 2 is a block diagram illustrating a configuration example of the HMD;

FIG. 3 is a diagram for describing specifying of visually recognized objects;

FIG. 4 is a flowchart illustrating an example of a process for specifying a visually recognized object;

FIG. 5 is a diagram for describing specifying of visually recognized attribute information according to Embodiment 1;

FIG. 6 is a flowchart illustrating an example of a process for specifying the visually recognized attribute information;

FIG. 7 is a block diagram illustrating a configuration example of an information processing system according to Embodiment 2;

FIG. 8 is a diagram for describing specifying of visually recognized attribute information according to Embodiment 2;

FIG. 9 is a flowchart illustrating an example of a collected-information presenting process according to Embodiment 2;

FIG. 10 is a flowchart illustrating an example of processing for transmitting the visually recognized attribute information to the server;

FIG. 11 is a diagram illustrating examples of information collected based on the visually recognized attribute information; and

FIG. 12 is a flowchart illustrating an example of an information collection process according to Embodiment 2.

### DESCRIPTION OF THE EMBODIMENTS

Hereinafter, embodiments of the present invention will be described with reference to the drawings.

### Embodiment 1

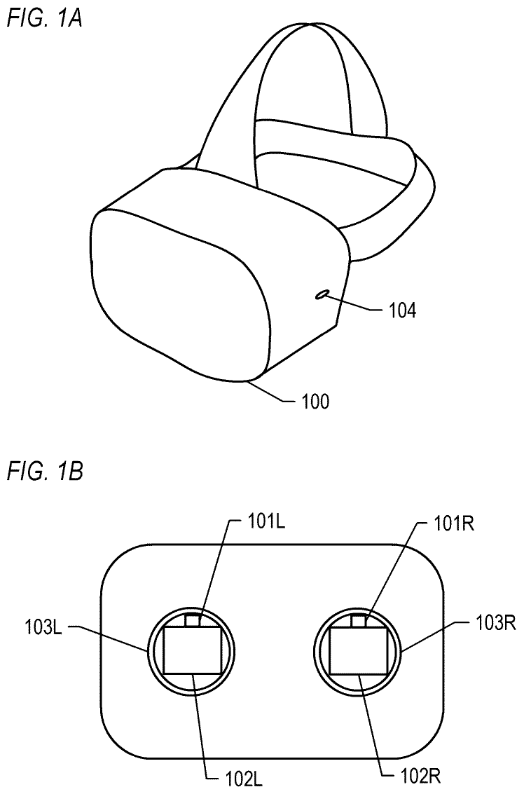

FIGS. 1A and 1B are external views of an HMD 100 as an example of an electronic device to which the present invention is applicable. FIG. 1A is a front perspective view of the HMD 100. FIG. 1B is a diagram illustrating the back side of the HMD 100 (the side closer to the eyes of the user).

The HMD 100 includes an eye information acquisition unit 101, a display unit 102, a display unit lens 103, and a power button 104. The eye information acquisition unit 101 includes a left-eye information acquisition unit 101L for the left eye and a right-eye information acquisition unit 101R for the right eye. The eye information acquisition unit 101 can acquire information about the eyes of the user looking into a finder.

The display unit 102 includes a left-eye display unit 102L for the left eye and a right-eye display unit 102R for the right eye. The display unit 102 displays an image, various kinds of information, and a graphical user interface (GUI) of a setting screen.

The display unit lenses 103 include a left-eye display unit lens 103L for the left eye and a right-eye display unit lens 103R for the right eye. The display unit lenses 103 include a zoom lens and a focus lens protected by a barrier member, and is designed to focus on the display unit 102. The power button 104 is a user interface for turning on and off the power.

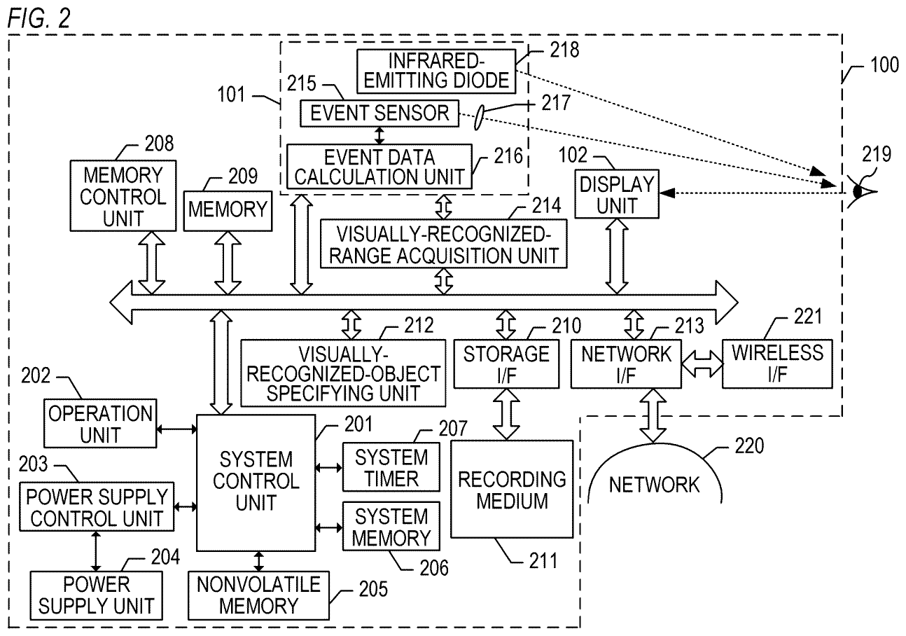

FIG. 2 is a block diagram illustrating an example of a configuration of the HMD 100. A system control unit 201 is a central processing unit of a microcomputer built in the HMD 100, and controls the entire HMD 100. The system control unit 201 realizes processing of functional units by executing programs recorded in a nonvolatile memory 205.

The system control unit 201 performs display control by controlling a display unit 102, a memory control unit 208, a memory 209, and the like. The system control unit 201 can read information to be displayed on the display unit 102 from the memory 209 or a recording medium 211.

The recording medium 211 stores information regarding an object (hereinafter, also referred to as object information). The object information may be acquired from an external device on a network 220 or a cloud via a network interface 213. The system control unit 201 can read the object information stored in the recording medium 211 or the object information acquired via the network interface 213 into the memory 209 and refer thereto.

The object information includes information about the type of object, attribute information about the object, etc. The attribute information is not limited to attribute information represented by a numerical value, and may be attribute information representing a classification. The object has one or more attributes. The attribute of the object can be determined in advance by the user, for example. The attribute of the object may be determined for each type of object.

The object information further includes information about the display position (coordinates) and the display size of the object on the display image. In a case where the attribute information is displayed together with the object, the object information includes information about the display position (coordinates) and the display size of the attribute information on the display image.

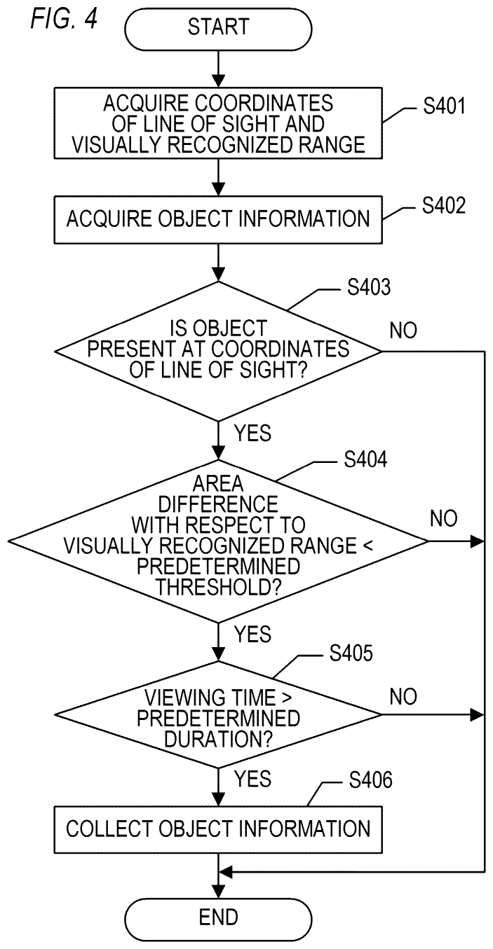

The nonvolatile memory 205 is an electrically erasable and recordable memory, and is, for example, an Electrically Erasable Programmable Read-Only Memory (EEPROM) (registered trademark). The nonvolatile memory 205 stores constants for the operation of the system control unit 201, programs, etc. The programs stored in the nonvolatile memory 205 includes programs for executing processing illustrated in FIGS. 4, 6, 9, 10, and 12. The system memory 206 is, for example, a Random Access Memory (RAM). The system memory 206 expands constants for the operation of the system control unit 201, variables, a program read from the nonvolatile memory 205, and the like and is used as a work memory of the system control unit 201. A system timer 207 measures time used for various kinds of control and time on a built-in clock.

The display unit 102 is a display device (display) such as a liquid crystal display (LCD), and performs display in accordance with digital signals from the memory 209. Although the display unit 102 is illustrated as a single functional unit in FIG. 2, the display unit 102 includes the left-eye display unit 102L for the left eye and the right-eye display unit 102R for the right eye, which correspond to the left and right eyes, respectively. Output data from the system control unit 201 is written into the memory 209 via the memory control unit 208 or directly written into the memory 209. The memory 209 stores image data to be displayed on the display unit 102. The memory 209 has a storage capacity sufficient for storing a predetermined length of video and audio.

A power supply control unit 203 includes a battery detection circuit, a DC-DC converter, and a switch circuit for switching a block to be energized. The power supply control unit 203 can detect whether a battery is attached, the type of battery, and the remaining battery level. Based on these detection results, the power supply control unit 203 controls the DC-DC converter in accordance with an instruction from the system control unit 201, and supplies a voltage to be used to each unit including the recording medium 211.

A power supply unit 204 includes a primary battery such as an alkaline battery or a lithium battery, a secondary battery such as a NiCd battery, a NiMH battery, or a Li battery, and an AC adapter, or the like. A storage interface 210 is a communication interface with the recording medium 211. The recording medium 211 is a recording medium such as a memory card or a hard disk, and examples of the recording medium 211 include a semiconductor memory, a magnetic disk, and the like.

An operation unit 202 is an operation member for inputting various instructions to the HMD 100, and notifies the system control unit 201 of information regarding an operation from the user. The operation unit 202 includes, for example, the power button 104. Upon receiving the notification that the power button 104 has been pressed, the system control unit 201 instructs the power supply control unit 203 to shift the state of the HMD 100 to a power-off state if the HMD 100 is in a power-on state and to shift the state of the HMD 100 to a power-on state if the HMD 100 is in a power-off state.

The network interface 213 is an interface that allows the HMD 100 to communicate with the network 220 such as a Local Area Network (LAN) or the Internet based on an instruction from the system control unit 201. A wireless interface 221 is an interface for communicating with an external device by a wireless communication method such as Wi-Fi and Bluetooth (registered trademark).

The eye information acquisition unit 101 includes an event sensor 215, an event data calculation unit 216, a line-of-sight detection lens 217, and an infrared-emitting diode 218. Although the eye information acquisition unit 101 is illustrated as a single functional unit in FIG. 2, the eye information acquisition unit 101 includes a left-eye information acquisition unit 101L for the left eye and a right-eye information acquisition unit 101R for the right eye, which correspond to the left and right eyes, respectively. The eye information acquisition unit 101 can detect eyes 219 of the user and acquire information (eye information) regarding the eyes of the user. The infrared light emitted from the infrared-emitting diode 218 is reflected by the eyes 219 of the user, and the reflected infrared light passes through the line-of-sight detection lens 217 and forms an image on the imaging surface of the event sensor 215.

The event sensor 215 is an event-based vision sensor that detects a change in luminance of light incident on each pixel, and outputs information about the pixel in which a luminance change has occurred, asynchronously with other pixels. The data output from the event sensor 215 (hereinafter, referred to as event data) includes, for example, position coordinates of a pixel in which an event of a luminance change has occurred, a polarity (positive or negative) of the luminance change, and timing information corresponding to an event occurrence time. As compared with a frame-based type synchronous sensor, the event sensor 215 has reduced redundancy of information to be output, and has features of high-speed operation, a high dynamic range, and low power consumption.

The event data calculation unit 216 acquires (detects) information regarding the eyes 219 of the user based on the event data asynchronously and continuously output from the event sensor 215. The event data (information about a pixel in which a luminance change has occurred) is asynchronously output data of information about each pixel. Therefore, the event data calculation unit 216 accumulates event data output from the event sensor 215 for a predetermined duration of time and performs various kinds of calculation processing on the accumulated data in order to determine the relevance among the event data. For example, the event data calculation unit 216 accumulates event data generated during a predetermined duration of time and processes the accumulated event data as a set of data so as to acquire the eye information. The event data calculation unit 216 can acquire a plurality of pieces of eye information having different generation speeds by changing the accumulation time for accumulating the event data.

The eye information includes, for example, line-of-sight position information regarding a line-of-sight position (a position at which the user is looking), saccade information regarding the direction and the speed of a saccade, and microsaccade information regarding the occurrence frequency and the amplitude (an amount of change in the line-of-sight position) of a microsaccade. The eye information may include information regarding eye movements other than saccades and microsaccades, pupil information regarding the size of a pupil and a change in pupil diameter, and blink information regarding the speed and the number of blinks. These kinds of information are merely examples, and the eye information is not limited to these kinds of information.

The event data calculation unit 216 may perform image processing by mapping the event data accumulated during the accumulation time as one frame of image data based on the event occurrence coordinates (the position coordinates of the pixel in which the event of a luminance change has occurred). With the above configuration, the event data calculation unit 216 can acquire the eye information from one frame of image data obtained by mapping the event data accumulated during the accumulation time by using the method of frame-based image processing.

A visually-recognized-range acquisition unit 214 estimates (acquires) a visually recognized range of the user based on the eye information obtained by the event data calculation unit 216. The visually-recognized-range acquisition unit 214 can determine the size (area) of the visually recognized range or an observation level (non-observation level) from the frequency and amplitude of microsaccades, for example. The visually recognized range is synonymous with an attention range or a focus range. The index of the observation level is higher as the visually recognized range is narrower and is lower as the visually recognized range is wider. The non-observation level is defined as an antonym of the observation level.

The visually-recognized-range acquisition unit 214 can be configured by a neural network or the like that receives parameters related to microsaccade, blinking, pupil diameter, and the like as input and outputs a visually recognized range and an observation level. However, the method for determining the visually recognized range and the observation level is not limited to the method using the neural network. The visually-recognized-range acquisition unit 214 may determine the visually recognized range and the observation level by another method.

The visually-recognized-range acquisition unit 214 may acquire the visually recognized range by using not only the information about the microsaccade, the blinking, and the pupil diameter but also various kinds of information included in the eye information. The eye information includes position information, the direction of a saccade, the speed of a saccade, the occurrence frequency of a microsaccade, the amplitude of a microsaccade, the size of a pupil, a change in pupil diameter, the speed of a blink, and the number of blinks. The visually-recognized-range acquisition unit 214 can estimate the visually recognized range based on any information included in the eye information or information obtained by appropriately combining two or more pieces of information included in the eye information.

A visually-recognized-object specifying unit 212 specifies an object and attribute information that are visually recognized by the user based on the object information and the visually recognized range of the user. In a case where the area difference between the visually recognized range of the user and the display range of an object present in the visually recognized range is smaller than a predetermined threshold, the visually-recognized-object specifying unit 212 specifies the object present in the visually recognized range as the object visually recognized by the user. In addition, when the line of sight of the user is directed toward an object present in the visually recognized range for a duration longer than a predetermined duration, the visually-recognized-object specifying unit 212 may specify the object present in the visually recognized range as the object visually recognized by the user. Further, when the area difference is smaller than the predetermined threshold and the duration (viewing time) during which the line of sight of the user is directed toward the object is longer than the predetermined duration, the visually-recognized-object specifying unit 212 may specify the object present in the visually recognized range as the object visually recognized by the user.

In a case where attribute information is displayed together with the object, the visually-recognized-object specifying unit 212 specifies attribute information visually recognized by the user based on the attribute information of the object information and the visually recognized range of the user. In a case where the area difference between the visually recognized range of the user and the display range of attribute information present in the visually recognized range is smaller than a predetermined threshold, the visually-recognized-object specifying unit 212 specifies the attribute information present in the visually recognized range as the attribute information visually recognized by the user. In addition, when the line of sight of the user is directed toward attribute information present in the visually recognized range for a duration longer than a predetermined duration, the visually-recognized-object specifying unit 212 may specify the attribute information present in the visually recognized range as the attribute information visually recognized by the user. Further, when the area difference is smaller than the predetermined threshold and the duration during which the line of sight of the user is directed toward the attribute information is longer than the predetermined duration, the visually-recognized-object specifying unit 212 may specify the attribute information present in the visually recognized range as the attribute information visually recognized by the user.

The condition for specifying the object or the attribute information visually recognized by the user is not limited to the conditions about the area difference and the viewing time, and the condition may be a condition that varies depending on the type of the object. The condition for specifying the object or the attribute information visually recognized by the user may be different for each user.

The object or the attribute information visually recognized by the user is stored in the memory 209 and can be referred to by the system control unit 201. In addition, the system control unit 201 can transmit the object or the attribute information visually recognized by the user to an external apparatus or the like via the network interface 213.

Embodiment 1 can be applied not only to the HMD 100 but also to electronic apparatuses such as PCs and tablet terminals, which are used in a state where the user and the display unit 102 are more distant from each other than in the case of the HMD 100.

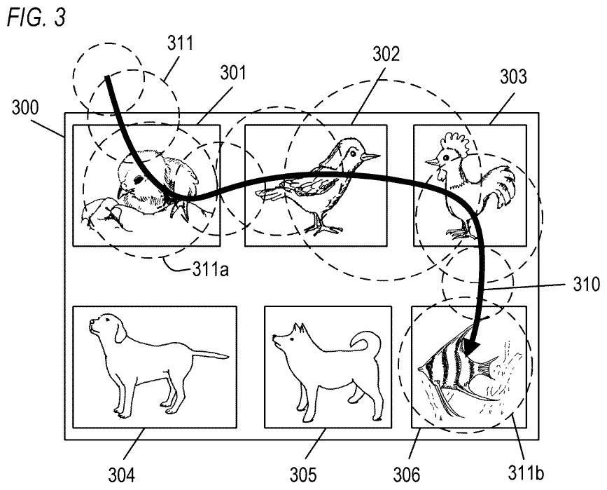

Specifying of visually recognized objects will be described with reference to FIG. 3. The HMD 100 specifies a visually recognized object based on the eye information and acquires object information about the specified object. FIG. 3 illustrates an example of a screen 300 displayed on the display unit 102 of the HMD 100. Objects 301 to 306 are a group of images displayed in a matrix. The display size of the objects 301 to 306 varies for each object.

A line-of-sight shift trajectory 310 represents how the coordinates indicating the position of the line of sight of the user (hereinafter, the coordinates of the line of sight) have shifted with respect to the screen 300. A visually-recognized-range shift trajectory 311 indicated by a plurality of circles (circles surrounded by dotted lines) represents how the visually recognized range of the user has shifted in accordance with the line-of-sight shift trajectory 310 with respect to the screen 300. The visually recognized object viewed by the user is specified based on the display size of the object on the screen 300, the line-of-sight shift trajectory 310, and the visually-recognized-range shift trajectory 311.

A process for specifying a visually recognized object will be described with reference to FIG. 4. FIG. 4 is a flowchart illustrating an example of a process for specifying a visually recognized object. In step S401, the system control unit 201 acquires the coordinates of a line of sight and a visually recognized range. Information on the coordinates of the line of sight is included in the eye information acquired by the eye information acquisition unit 101. Information on the visually recognized range is acquired by the visually-recognized-range acquisition unit 214.

In step S402, the system control unit 201 acquires object information on an object displayed on the display unit 102. The object information acquired in step S402 includes information on the display position and the display size of the object.

In step S403, the system control unit 201 determines whether or not there is any object present at the coordinates of the line of sight. For example, when the coordinates of the line of sight acquired in step S401 approximately matches the display position of an object, the system control unit 201 can determine that the object is present at the coordinates of the line of sight. The display position of the object can be, for example, the coordinates of the center or the center of gravity of the display range of the object (the area in which the object is displayed). If the object is present at the coordinates of the line of sight, the processing proceeds to step S404. If no object is present at the coordinates of the line of sight, the process illustrated in FIG. 4 ends.

In step S403, the system control unit 201 only needs to determine whether or not an object is present in the visually recognized range of the user. The system control unit 201 may determine that an object is present at the coordinates of the line of sight when, for example, the coordinates of the line of sight are included in the display range of the object or in a part of the display range of the object, that is, the determination is not limited to the case where the coordinates of the line of sight approximately match the display position of the object.

In step S404, the system control unit 201 determines whether or not the area difference between the display range of the object determined to be present in the visually recognized range of the user in step S403 and the visually recognized range of the user is smaller than a predetermined threshold. If the area difference is smaller than the predetermined threshold, the processing proceeds to step S405. If the area difference is equal to or larger than the predetermined threshold, the process illustrated in FIG. 4 ends.

In step S405, the system control unit 201 determines whether or not a duration (viewing time) during which the line of sight of the user is continuously directed toward the object is longer than a predetermined duration. For example, when the amount of change in the coordinates of the line of sight within a predetermined duration of time is smaller than a predetermined value, the system control unit 201 can determine that the duration during which the line of sight of the user is directed toward the object is longer than the predetermined duration. If the duration during which the line of sight of the user is directed toward the object is longer than the predetermined duration, the process proceeds to step S406. If the duration during which the line of sight of the user is directed toward the object is equal to or less than the predetermined duration, the processing illustrated in FIG. 4 ends.

Alternatively, any one of the determination performed in step S404 and the determination performed in step S405 may be omitted. That is, when the condition set in either step S404 or step S405 is satisfied, the system control unit 201 may advance the processing to step S406.

In step S406, the system control unit 201 specifies the object determined to be present in the visually recognized range of the user in step S403 as the visually recognized object, and collects information related to the specified visually recognized object.

In the example in FIG. 3, it is assumed that the object 301 is present in a visually recognized range 311a, and the area difference between the display range of the object 301 and the visually recognized range 311a is smaller than the predetermined threshold. Similarly, it is assumed that the object 306 is present in a visually recognized range 311b and the area difference between the display range of the object 306 and the visually recognized range 311b is smaller than the predetermined threshold. Therefore, the system control unit 201 specifies the bird of the object 301 and the fish of the object 306 as the visually recognized objects.

The system control unit 201 collects information related to the bird or the fish in which the user has shown interest. For example, the system control unit 201 can collect information on an object related to the bird or the fish from information on a plurality of objects stored in the recording medium 211. The system control unit 201 may collect information on an object related to the bird or the fish from an external device via the network 220, not only from the recording medium 211. The system control unit 201 can collect information related to the bird or the fish in which the user has shown interest and present the collected information to the user.

According to the process in FIG. 4, the HMD 100 can specify the visually recognized object based on the display range (size) of the object displayed on the display unit 102, the line-of-sight shift trajectory 310, and the visually-recognized-range shift trajectory 311, and collect information related to the visually recognized object. The HMD 100 can accurately specify the visually recognized object and can collect and present information related to the subject (visually recognized object) in which the user has shown interest.

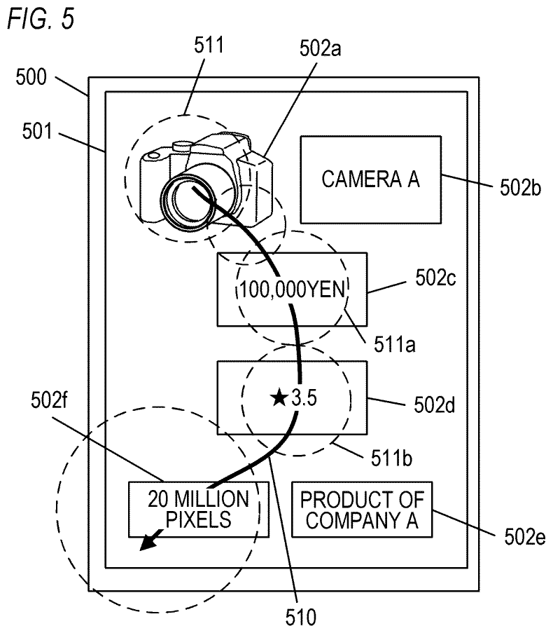

A case where attribute information is displayed together with an object and the attribute information (also referred to as visually recognized attribute information) visually recognized by the user is specified will be described with reference to FIG. 5. As processing for specifying the object (visually recognized object) visually recognized by the user, the HMD 100 specifies attribute information visually recognized by the user among pieces of attribute information displayed together with a visually recognized object. The HMD 100 specifies the attribute information visually recognized by the user based on the eye information and acquires the specified attribute information.

The attribute information displayed together with the object is displayed in a size that allows the user to recognize the attribute information. The HMD 100 displays the attribute information in a size recognizable for the user so that the visually recognized attribute information can be specified in a state where the user recognizes the content of the attribute information.

FIG. 5 illustrates an example of a screen 500 displayed on the display unit 102 of the HMD 100. Attribute information 502a to 502f indicate attribute information associated with an object 501. The display size of the attribute information 502a to 502f varies for each piece of attribute information.

The attribute information of the object is represented by classifications, parameters (numerical values), and the like. In the example in FIG. 5, the object 501 is a camera, and has attributes such as an image, a model, a price, an evaluation, a manufacturer (production source), and the number of pixels. The attribute information such as the model and the manufacturer is represented as a classification. The attribute information such as the price, the evaluation, and the number of pixels is represented by a numerical value.

A line-of-sight shift trajectory 510 represents how the coordinates of the line of sight of the user have shifted with respect to the screen 500. A visually-recognized-range shift trajectory 511 indicated by a plurality of circles (circles surrounded by dotted lines) represents how the visually recognized range of the user has shifted in accordance with the line-of-sight shift trajectory 510 with respect to the screen 500. The attribute information visually recognized by the user is specified based on the display size of the attribute information on the screen 500, the line-of-sight shift trajectory 510, and the visually-recognized-range shift trajectory 511.

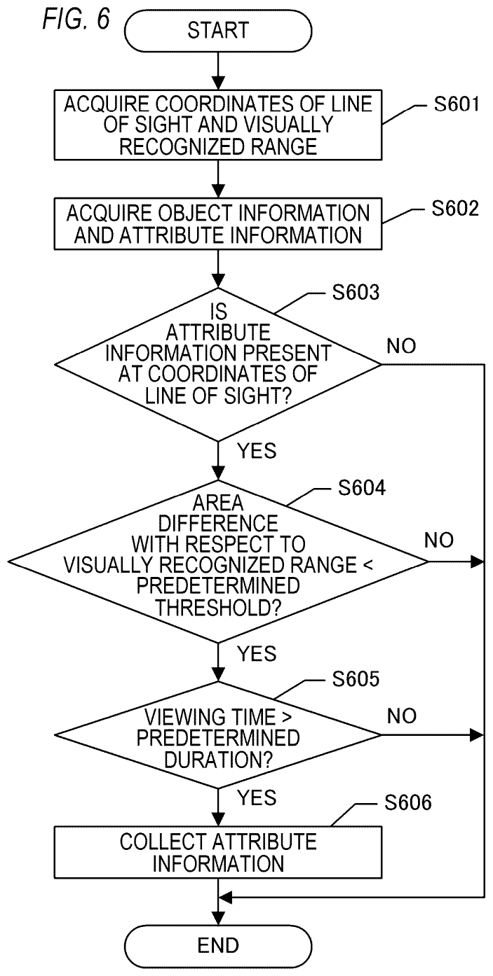

A process for specifying attribute information visually recognized by the user will be described with reference to FIG. 6. FIG. 6 is a flowchart illustrating an example of a process for specifying visually recognized attribute information. In step S601, the system control unit 201 acquires the coordinates of a line of sight and a visually recognized range. Information on the coordinates of the line of sight is included in the eye information acquired by the eye information acquisition unit 101. Information on the visually recognized range is acquired by the visually-recognized-range acquisition unit 214.

In step S602, the system control unit 201 acquires object information on an object displayed on the display unit 102 and attribute information corresponding to the object. The object information acquired in step S602 includes information on the display position and the display size of the object and information on the display position and the display size of the individual piece of the attribute information corresponding to the object.

In step S603, the system control unit 201 determines whether or not there is any attribute information present (displayed) at the coordinates of the line of sight. For example, when the coordinates of the line of sight acquired in step S601 approximately matches the display position of attribute information, the system control unit 201 can determine that the attribute information is present at the coordinates of the line of sight. The display position of attribute information can be, for example, the coordinates of the center or the center of gravity of the display range of the attribute information (the area in which the attribute information is displayed). If the attribute information is present at the coordinates of the line of sight, the processing proceeds to step S604. If no attribute information is present at the coordinates of the line of sight, the process illustrated in FIG. 6 ends.

In step S603, the system control unit 201 only needs to determine whether or not attribute information is present in the visually recognized range of the user. The system control unit 201 may determine that attribute information is present at the coordinates of the line of sight when, for example, the coordinates of the line of sight are included in the display range of the attribute information or in a part of the display range of the attribute information, that is, the determination is not limited to the case where the coordinates of the line of sight approximately match the display position of the attribute information.

In step S604, the system control unit 201 determines whether or not the area difference between the display range of the attribute information determined to be present in the visually recognized range of the user in step S603 and the visually recognized range of the user is smaller than a predetermined threshold. If the area difference is smaller than the predetermined threshold, the processing proceeds to step S605. If the area difference is equal to or larger than the predetermined threshold, the process illustrated in FIG. 6 ends.

In step S605, the system control unit 201 determines whether or not a duration (viewing time) during which the line of sight of the user is continuously directed toward the attribute information is longer than a predetermined duration. For example, when the amount of change in the coordinates of the line of sight within a predetermined duration of time is smaller than a predetermined value, the system control unit 201 can determine that the duration during which the line of sight of the user is directed toward the attribute information is longer than the predetermined duration. If the duration during which the line of sight of the user is directed toward the attribute information is longer than the predetermined duration, the processing proceeds to step S606. If the duration during which the line of sight of the user is directed toward the attribute information is equal to or less than the predetermined duration, the process illustrated in FIG. 6 ends.

Alternatively, any one of the determination performed in step S604 and the determination performed in step S605 may be omitted. That is, when the condition set in either step S604 or step S605 is satisfied, the system control unit 201 may advance the processing to step S606.

In step S606, the system control unit 201 specifies the attribute information determined to be present in the visually recognized range of the user in step S603 as the visually recognized attribute information, and collects information related to the specified attribute information.

In the example in FIG. 5, it is assumed that attribute information 502c is present in a visually recognized range 511a, and the area difference between the display range of the attribute information 502c and the visually recognized range 511a is smaller than a predetermined threshold. Similarly, it is assumed that attribute information 502d is present in a visually recognized range 511b and the area difference between the display range of the attribute information 502d and the visually recognized range 511b is smaller than the predetermined threshold. Therefore, the visually-recognized-object specifying unit 212 specifies the price of the attribute information 502c and the evaluation of the attribute information 502d as the attribute information visually recognized by the user.

The system control unit 201 acquires the attribute information on the price and the evaluation in which the user has shown interest. In the example in FIG. 5, the attribute information on the price in which the user has shown interest is 100,000 yen, and the attribute information on the evaluation is 3.5 stars. The system control unit 201 collects information about a camera whose price is around 100,000 yen and information about a camera whose evaluation is around 3.5 based on the acquired attribute information. The system control unit 201 can collect information about the camera based on the attribute information visually recognized by the user from the recording medium 211, an external apparatus, or the like. The system control unit 201 can collect and present information related to the camera visually recognized by the user based on the attribute information in which the user has shown interest.

According to the process in FIG. 6, the HMD 100 can specify the visually recognized attribute information based on the display range (size) of the attribute information displayed on the display unit 102, the line-of-sight shift trajectory 510, and the visually-recognized-range shift trajectory 511, and collect information related to the visually recognized object. The visually recognized object is an object displayed together with the visually recognized attribute information viewed by the user (an object corresponding to the visually recognized attribute information). The HMD 100 can accurately specify the visually recognized attribute information, and can collect and present information related to the subject (object corresponding to the visually recognized attribute information) in which the user has shown interest.

According to Embodiment 1, the HMD 100 can accurately specify the object or the attribute information visually recognized by the user among the objects displayed on the display unit 102, and can collect and present information that better matches the interest of the user.

### Embodiment 2

Embodiment 2 is an embodiment about a method in which an HMD 100 collects information to be presented to the user based on the object and the attribute information specified by a visually-recognized-object specifying unit 212. In Embodiment 2, the HMD 100 acquires information to be presented to the user from a server (information processing apparatus). Among pieces of attribute information displayed together with a visually recognized object, the server acquires the attribute information specified as being visually recognized by the user based on a visually recognized range of the user, and collects information related to the visually recognized object based on the acquired attribute information.

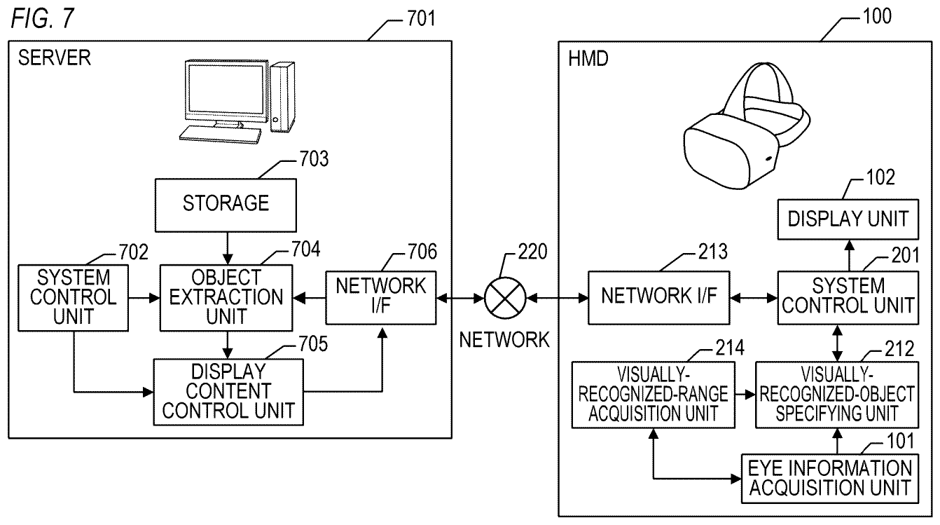

Embodiment 2 can also be applied to a case where the HMD 100 operates alone by providing the HMD 100 with a configuration of the server described with reference to FIG. 7. Detailed description of the same processing as that in Embodiment 1 will be omitted.

FIG. 7 is a block diagram illustrating a configuration example of an information processing system according to Embodiment 2. The information processing system includes a server 701 and the HMD 100. The HMD 100 has the same configuration as that in FIG. 2, and thus, detailed description thereof will be omitted. FIG. 7 illustrates a part of the configuration of the HMD 100 described with reference to FIG. 2.

The server 701 is a Web server that transmits information to be displayed on the display unit 102 to the HMD 100 via the network 220. The server 701 includes a system control unit 702, a storage 703, an object extraction unit 704, a display content control unit 705, and a network interface (I/F) 706. The system control unit 702 controls the entire server 701.

The storage 703 stores object information to be displayed on the display unit 102 of the HMD 100 and presented to the user. The object extraction unit 704 extracts the object information to be presented to the user from the information stored in the storage 703, and transmits the extracted object information to the display content control unit 705. The object information is not limited to the information stored in the storage 703, and the object extraction unit 704 may extract object information from information acquired from the outside via the network interface 706.

The display content control unit 705 converts the object information received from the object extraction unit 704 into a format displayable on the HMD 100, and transmits the converted object information to the HMD 100. The network interface 706 is an interface for communicating with the HMD 100 via the network 220 such as a Local Area Network (LAN) or the Internet. The system control unit 201 of the HMD 100 receives the object information converted by the display content control unit 705 via the network interface 706, the network 220, and the network interface 213 of the HMD 100. The system control unit 201 displays the received object information on the display unit 102.

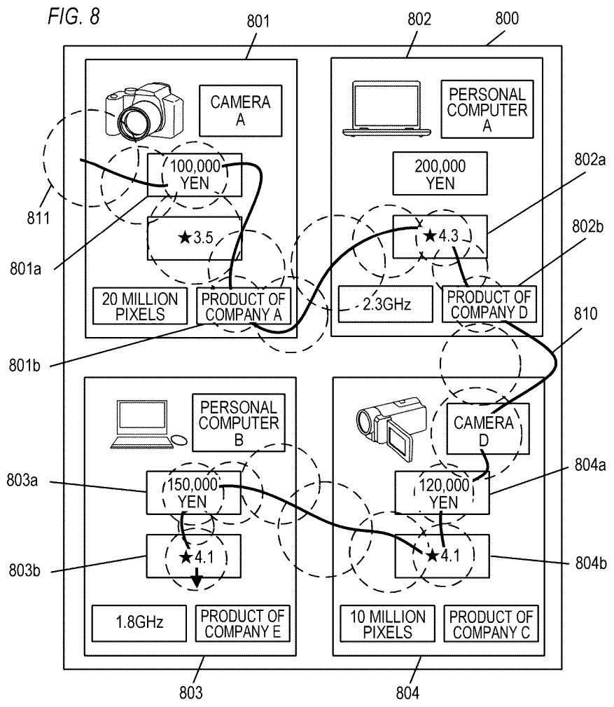

A case where a plurality of objects is displayed together with their respective pieces of attribute information and the attribute information visually recognized by the user is specified will be described with reference to FIG. 8. FIG. 8 illustrates an example of a screen 800 displayed on the display unit 102 of the HMD 100.

Objects 801 to 804 are displayed together with their respective pieces of attribute information. Each object is classified by the type of object such as a camera and a personal computer, and is displayed together with attribute information corresponding to the type. In the example in FIG. 8, the objects 801 and 804 whose type is a camera are each displayed together with the attribute information such as the image, the model, the price, the evaluation, the manufacturer, and the number of pixels. The objects 802 and 803 whose type is a personal computer are each displayed together with the attribute information such as the image, the model, the price, the evaluation, the manufacturer, and the clock speed.

A line-of-sight shift trajectory 810 represents how the coordinates of the line of sight of the user have shifted with respect to the screen 800. A visually-recognized-range shift trajectory 811 indicated by a plurality of circles (circles surrounded by dotted lines) represents how the visually recognized range of the user has shifted in accordance with the line-of-sight shift trajectory 810 with respect to the screen 800.

The visually-recognized-object specifying unit 212 specifies the attribute information (visually recognized attribute information) viewed by the user based on the display range (size) of the attribute information displayed on the display unit 102, the line-of-sight shift trajectory 810, and the visually-recognized-range shift trajectory 811. In the example in FIG. 8, the visually-recognized-object specifying unit 212 specifies the price, represented as attribute information 801a, and the manufacturer, represented as attribute information 801b, of the object 801 and the price, represented as attribute information 804a, and the evaluation, represented as attribute information 804b, of the object 804 as the visually recognized attribute information. Further, the visually-recognized-object specifying unit 212 specifies the evaluation, represented as attribute information 802a, and the manufacturer, represented as attribute information 802b, of the object 802 and the price, represented as attribute information 803a, and the evaluation, represented as attribute information 803b, of the object 803 as the visually recognized attribute information.

The system control unit 201 transmits the specified attribute information (visually recognized attribute information) to the object extraction unit 704 of the server 701 via the network 220. The system control unit 201 may transmit, together with the visually recognized attribute information, information about the visually recognized object corresponding to the visually recognized attribute information. In addition to the attribute information, the server 701 collects, for example, information related to the visually recognized object based on the type of the visually recognized object.

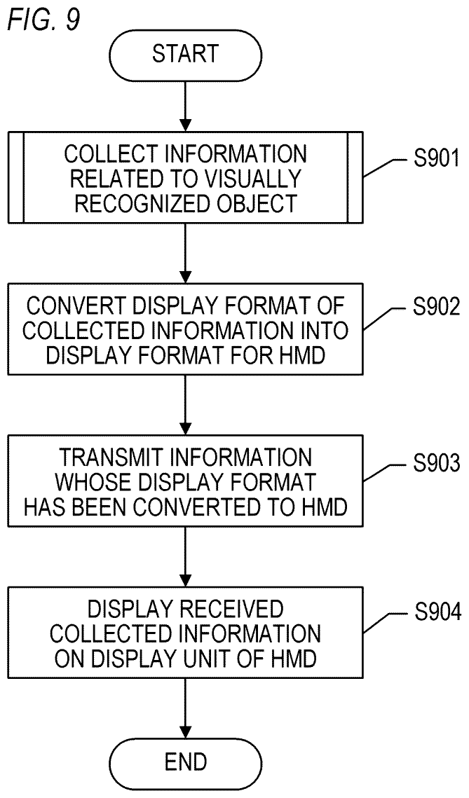

FIG. 9 is a flowchart illustrating an example of a collected-information presenting process. The collected-information presenting process is a process in which the server 701 collects information related to the visually recognized object based on the information received from the HMD 100 and causes the HMD 100 to present the collected information to the user.

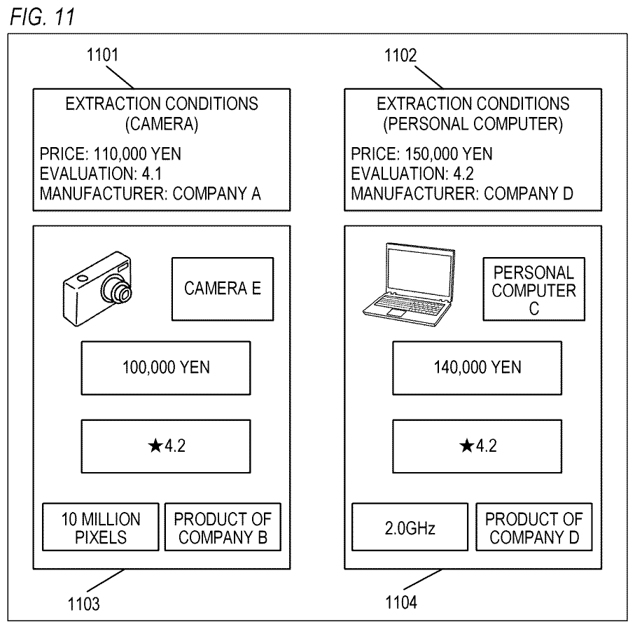

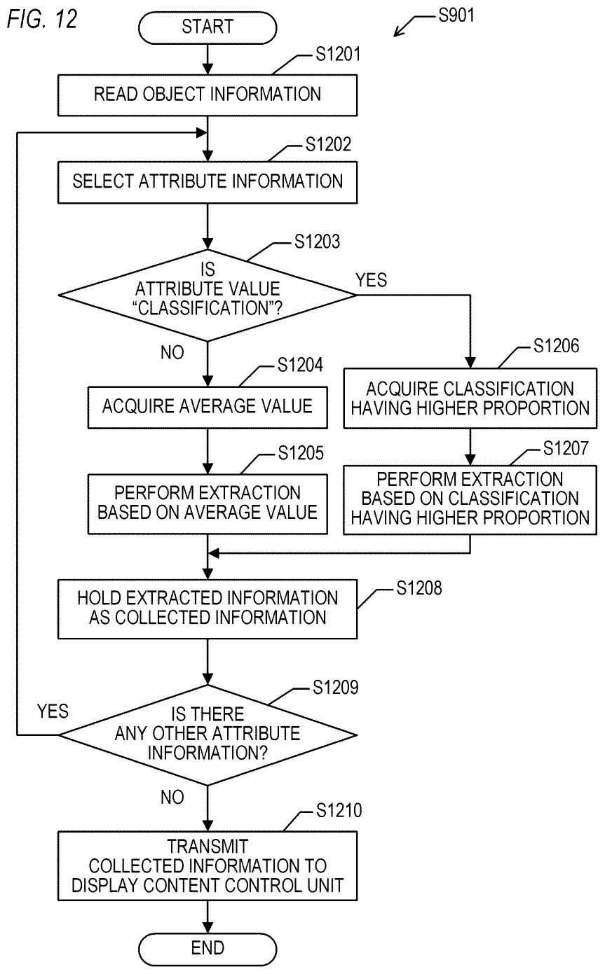

In step S901, the system control unit 702 collects information related to the visually recognized object. Specifically, the system control unit 702 extracts object information related to the visually recognized object from a plurality of pieces of object information stored in the storage 703 based on the attribute information and the information on the visually recognized object received from the HMD 100. A specific example of the extracted information and details of an extraction method will be described below with reference to FIGS. 11 and 12.

In step S902, the display content control unit 705 converts the display format of the object information collected in step S901 into a display format to be displayed on the HMD 100. In step S903, the display content control unit 705 transmits the object information whose display format has been converted to the HMD 100 via the network 220. In step S904, the system control unit 201 of the HMD 100 can present the collected information related to the visually recognized object to the user by displaying the information received from the server 701 on the display unit 102.

By the above process, the HMD 100 can display the object information related to the object visually recognized by the user (the visually recognized object corresponding to the visually recognized attribute information) on the display unit 102.

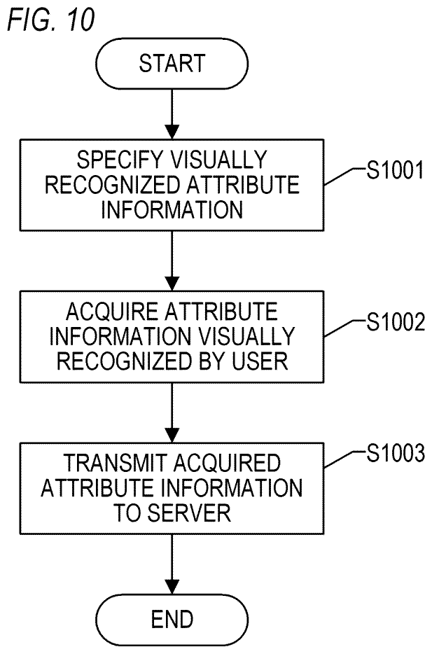

FIG. 10 is a flowchart illustrating an example of a process for transmitting the visually recognized attribute information to the server 701. The HMD 100 may transmit information on the visually recognized object corresponding to the visually recognized attribute information, such as the type of the object, to the server 701.

In step S1001, the visually-recognized-object specifying unit 212 specifies attribute information visually recognized by the user based on the visually recognized range of the user or the like. The visually-recognized-object specifying unit 212 can specify a plurality of pieces of attribute information. In step S1002, the system control unit 201 acquires the attribute information visually recognized by the user. In step S1003, the system control unit 201 transmits the attribute information acquired in step S1002 to the server 701 via the network 220.

By the above process, the HMD 100 transmits one or more pieces of attribute information visually recognized by the user to the server 701. The server 701 can collect information related to the visually recognized object (the visually recognized object corresponding to the visually recognized attribute information) based on the information received from the HMD 100.

FIG. 11 illustrates examples of information related to the visually recognized object collected based on the visually recognized attribute information. In the example in FIG. 8, the visually recognized attribute information about the camera is the attribute information 801a (price) and the attribute information 801b (manufacturer) of the object 801 and the attribute information 804a (price) and the attribute information 804b (evaluation) of the object 804. An extraction condition 1101 for the price of the camera is 110,000 yen, which is the average of the price of 100,000 yen for the object 801 and the price of 120,000 yen for the object 804. The extraction condition 1101 for the evaluation of the camera is 4.1, which is the evaluation of the object 804 since the evaluation of the object 801 is not visually recognized. The extraction condition 1101 for the manufacturer of the camera is Company A, which is the manufacturer of the object 801 since the manufacturer of the object 804 is not visually recognized. Note that if there are a plurality of pieces of visually recognized attribute information about the manufacturer, the manufacturer having the highest proportion among the pieces of attribute information about the manufacturer can be set as the extraction condition 1101 for the manufacturer.

In the example in FIG. 8, the visually recognized attribute information about the personal computer is the attribute information 802a (evaluation) and the attribute information 802b (manufacturer) of the object 802 and the attribute information 803a (price) and the attribute information 803b (evaluation) of the object 803. An extraction condition 1102 for the price of the personal computer is 150,000 yen, which is the price of the object 803 since the price of the object 802 is not visually recognized. The extraction condition 1102 for the evaluation of the personal computer is 4.2, which is the average of 4.3, which is the evaluation of the object 802, and 4.1, which is the evaluation of the object 803. The extraction condition 1102 for the manufacturer of the personal computer is Company D, which is the manufacturer of the object 802 since the manufacturer of the object 803 is not visually recognized. Note that if there are a plurality of pieces of visually recognized attribute information about the manufacturer, the manufacturer having the highest proportion among the pieces of attribute information about the manufacturer can be set as the extraction condition 1102 for the manufacturer.

The object extraction unit 704 can collect object information related to the visually recognized object based on the extraction conditions 1101 for the camera and the extraction conditions 1102 for the personal computer. The object extraction unit 704 collects information about the object that satisfies the extraction conditions 1101 for the camera from the objects whose object type is a camera. The object extraction unit 704 collects information about the object that satisfies the extraction conditions 1102 for the personal computer from the objects whose object type is a personal computer. In this way, the object extraction unit 704 can collect information related to the visually recognized object based on the type of the visually recognized object.

As the extraction condition for the attribute information representing the classification, such as the model and the manufacturer, among the pieces of visually recognized attribute information, the classification having the highest proportion can be set. As the extraction condition for the attribute information represented by a numerical value, such as the price, the evaluation, the number of pixels, and the clock speed, among the pieces of visually recognized attribute information, the average value of the attribute information can be set. The extraction condition for the attribute information represented by a numerical value is not limited to the average value of the attribute information, and may be the median value or the mode value of the attribute information.

An object 1103 in FIG. 11 is an object that is a camera extracted from the storage 703 by the object extraction unit 704 based on the extraction conditions 1101 for the camera. An object 1104 is an object that is a personal computer extracted from the storage 703 by the object extraction unit 704 based on the extraction conditions 1102 for the personal computer.

The object 1103 and the object 1104 are object information collected based on the attribute information visually recognized by the user. In this way, the object extraction unit 704 can collect information related to the visually recognized object based on the type of the visually recognized object and the visually recognized attribute information. The information related to the visually recognized object collected by the object extraction unit 704 is transmitted to the HMD 100 and presented to the user.

FIG. 12 is a flowchart illustrating an example of an information collection process according to Embodiment 2. The information collection process illustrated in FIG. 12 is an example of a specific process of step S901 in FIG. 9.

In step S1201, the system control unit 702 reads object information from the storage 703 into a memory (not illustrated) or the like. In steps S1202 to S1209, the system control unit 702 collects information related to the visually recognized object from the read information.

The system control unit 702 performs the processing of steps S1203 to S1208 for each attribute of the visually recognized attribute information received from the HMD 100. In the example in FIG. 8, the visually recognized attribute information received from the HMD 100 is the attribute information 801a, 801b, 802a, 802b, 803a, 803b, 804a, and 804b. The type of the object is a camera or a personal computer. The visually recognized attribute information about the camera is the attribute information 801a, 801b, 804a, and 804b, and includes the attribute information on the price, the manufacture, and the evaluation. The visually recognized attribute information about the personal computer is the attribute information 802a, 802b, 803a, and 803b, and includes the attribute information on the evaluation, the manufacturer, and the price.

In step S1202, the object extraction unit 704 selects any of the attributes from the visually recognized attribute information received from the HMD 100. In this step, the object extraction unit 704 also selects the attribute information of the same attribute of the same type (camera or personal computer). In the example in FIG. 8, when the attribute information 801a of the price of the object 801 (camera) is selected, the attribute information 804a of the price of the object 804 (camera) is also selected.

In step S1203, the object extraction unit 704 determines whether or not the attribute information selected in step S1202 is represented by a classification. If the attribute information is represented by a classification, the processing proceeds to step S1206. If the attribute information is represented by a numerical value, not a classification, the processing proceeds to step S1204.

In step S1204, the object extraction unit 704 acquires the average value of the attribute information selected in step S1202 as the extraction condition. In the example in FIG. 8, the object extraction unit 704 acquires 110,000 yen, which is the average value of 100,000 yen of the attribute information 801a and 120,000 yen of the attribute information 804a, as the extraction condition.

In step S1205, the object extraction unit 704 extracts an object having a value within a predetermined range including the average value acquired in step S1204 from the object information read from the storage 703 in step S1201. For example, as illustrated in FIG. 11, when the extraction condition 1101 for the price (average price) of the camera is 110,000 yen, the object extraction unit 704 extracts a camera whose price is in the range of 100,000 yen to 120,000 yen as the predetermined range.

In step S1206, the object extraction unit 704 acquires, as an extraction condition, the classification having the highest proportion among the pieces of attribute information selected in step S1202. For example, when the attribute information 802b of the manufacturer of the object 802 (personal computer) is selected in step S1202, the object extraction unit 704 acquires the manufacturer D as the extraction condition.

In step S1207, the object extraction unit 704 extracts an object having the classification acquired in step S1206 from the object information read from the storage 703 in step S1201. For example, as illustrated in FIG. 11, when the extraction condition 1102 for the manufacturer of the personal computer is Company D, the object extraction unit 704 extracts a personal computer manufactured by Company D.

In step S1208, the object extraction unit 704 holds object information extracted in step S1205 or step S1207 as collected information. In step S1209, the object extraction unit 704 determines whether or not there is other attribute information that has not been selected in step S1202 among the visually recognized attribute information received from the HMD 100. If there is other attribute information, the processing returns to step S1202. If there is no other attribute information, the processing proceeds to step S1210.

In step S1210, the object extraction unit 704 transmits the collected information held in step S1208 to the display content control unit 705. The system control unit 702 advances the processing to step S902 in FIG. 9.

According to Embodiment 2, the HMD 100 can accurately specify the attribute information visually recognized by the user among the objects displayed on the display unit 102, and collect related information in accordance with which attribute of the object the user is interested in. Therefore, the HMD 100 can present information that better matches the interest of the user.

The preferred embodiments of the present invention have thus been described. However, the present invention is not limited to these embodiments, and various modifications and changes can be made within the scope of the gist of the present invention. The configurations of the embodiments can be appropriately combined within the scope of the gist of the present invention.

In the present disclosure, for example, a description such as “at least one of XX, YY, and ZZ” means any of XX, YY, ZZ, a combination of XX and YY, a combination of XX and ZZ, a combination of YY and ZZ, or a combination of XX, YY, and ZZ.

According to the present invention, information that better matches the interest of the user can be collected and presented.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-143419, filed on Sep. 5, 2023, which is hereby incorporated by reference herein in its entirety.

What is claimed is:

1. An electronic device comprising:
a processor; and
a memory storing a program which, when executed by the processor, causes the electronic device to:
perform estimation processing for estimating a visually recognized range of a user;
perform specifying processing for specifying an object that is visually recognized by the user, based on the visually recognized range; and
perform collection processing for collecting information related to a visually recognized object, which is the object specified in the specifying processing,
wherein, in the specifying processing, attribute information that is visually recognized by the user is specified among pieces of attribute information displayed together with the visually recognized object, and
wherein, in the collection processing, information related to the visually recognized object is collected, based on the attribute information specified in the specifying processing.

2. The electronic device according to claim 1, wherein
in the collection processing, the information related to the visually recognized object is collected, based on a type of the visually recognized object.

3. The electronic device according to claim 1, wherein
the visually recognized object is displayed together with attribute information corresponding to a type of the visually recognized object, and
in the collection processing, the information related to the visually recognized object is collected, based on the type of the visually recognized object and the attribute information specified in the specifying processing.

4. The electronic device according to claim 1, wherein
in the collection processing, among a plurality of pieces of the attribute information specified in the specifying processing, information related to a classification having a highest proportion, based on attribute information representing a classification, is collected as the information related to the visually recognized object.

5. The electronic device according to claim 1, wherein
in the collection processing, among a plurality of pieces of the attribute information specified in the specifying processing, information related to an average value, a median value, or a mode value of attribute information represented by a numerical value is collected as the information related to the visually recognized object.

6. The electronic device according to claim 1, wherein
the attribute information displayed together with the visually recognized object is displayed in a size that allows the user to recognize the attribute information.

7. The electronic device according to claim 1, wherein
in the estimation processing, the visually recognized range is estimated based on at least any of line-of-sight position information, a saccade direction, a saccade speed, a microsaccade occurrence frequency, a microsaccade amplitude, a pupil size, a change in a pupil diameter, a blink speed, and a number of blinks.

8. The electronic device according to claim 1, wherein
in the specifying processing, in at least any of (1) a case where an area difference between a display range of attribute information present in the visually recognized range and the visually recognized range is smaller than a predetermined threshold and (2) a case where a duration, during which a line-of-sight of the user is directed toward the attribute information present in the visually recognized range, is longer than a predetermined duration, the attribute information present in the visually recognized range is specified as the attribute information visually recognized by the user.

9. The electronic device according to claim 1, wherein the program, when executed by the processor, causes the electronic device to further perform presenting processing for presenting, to the user, the information related to the visually recognized object collected in the collection processing.

10. A control method for an electronic device, the control method comprising:
estimating a visually recognized range of a user;
specifying an object that is visually recognized by the user, based on the visually recognized range; and
collecting information related to a visually recognized object, which is the object specified in the specifying,
wherein, in the specifying, attribute information that is visually recognized by the user is specified among pieces of attribute information displayed together with the visually recognized object, and
wherein, in the collecting, information related to the visually recognized object is collected based on the attribute information specified in the specifying.

11. A non-transitory computer readable medium that stores a program, wherein the program causes a computer to execute a control method for an electronic device, the control method comprising:
estimating a visually recognized range of a user;
specifying an object that is visually recognized by the user, based on the visually recognized range; and
collecting information related to a visually recognized object, which is the object specified in the specifying,
wherein, in the specifying, attribute information that is visually recognized by the user is specified among pieces of attribute information displayed together with the visually recognized object, and
wherein, in the collecting, information related to the visually recognized object is collected based on the attribute information specified in the specifying.
